(19) United States
(12) Patent Application Publication
(10) Pub. No.: US 2007/0146248 A1
(43) Pub. Date: Jun. 28, 2007

(54) FLAT PANEL DISPLAY

(76) Inventors: Hong-Ru Guo, Tainan City (TW); Chien Hsiang Huang, Sinying City (TW); Ming-Chun Tseng, Tainan City (TW)

Correspondence Address: FISH & RICHARDSON PC, P.O. BOX 1022, MINNEAPOLIS, MN, 55440-1022, US

(21) Appl. No.: 11/611,436

(22) Filed: Dec. 15, 2006

(30) Foreign Application Priority Data
Dec. 16, 2005 (TW) 94144664

(51) Int. Cl. G09G 3/30

(52) U.S. Cl. 345/76

(57) ABSTRACT

A flat panel display includes a plurality of pixel circuits. Each pixel circuit includes a light emitting device, a driving device to drive the light emitting device, and a storage device to store pixel data for controlling the driving device. The display includes a plurality of switches external to the plurality of pixel circuits, each switch being connected in series with a corresponding one or more of the light emitting devices.

### CROSS REFERENCE TO RELATED APPLICATIONS

The application claims priority to Taiwan Application No. 94144664, filed Dec. 16, 2005, the content of which is incorporated by reference.

### BACKGROUND OF THE INVENTION

The description relates to flat panel displays.

An organic light-emitting display can have a wide viewing angle, a high response speed, and a low power consumption. FIG. 1 is a circuit diagram of an example of a pixel circuit that uses current driving. The pixel circuit includes an organic light emitting diode (OLED) 103 and a driving transistor 109 for driving the OLED 103. A storage capacitor 107 stores pixel data for controlling the driving transistor 109. The operation of the pixel circuit is controlled by signals on a scan line 13, a control line 15, and a data line 11. The scan line 13 controls the switching of transistors 101 and 105. When the scan line 13 is enabled, the transistors 101 and 105 are turned on. At the same time, the voltage on the control line 15 is set to 0. Turning on the transistor 105 connects the gate and drain nodes of the driving transistor 109. Turning on the resistor 101 allows a driving current Idata on the data line 11 to charge the storage capacitor 107. After the capacitor 107 is charged, the scan line 13 is disabled so that the transistors 101 and 105 are turned off, and the voltage on the control line 15 is set to a high level. The voltage across the storage capacitor 107 controls the driving transistor 109 to drive the OLED 103 with a driving current I1.

### SUMMARY

In one aspect, in general, a display includes a plurality of pixel circuits, each pixel circuit including a light emitting device, a driving device to drive the light emitting device, and a storage device to store pixel data for controlling the driving device. The display also includes a plurality of switches external to the plurality of pixel circuits, each switch being connected in series with a corresponding one or more of the light emitting devices.

Implementations of the display can include one or more of the following features. Each switch is configured to prevent current from flowing in the corresponding one or more light emitting devices when corresponding storage devices are being charged with the pixel data. Each switch corresponds to the light emitting devices of at least two pixel circuits and prevents current from flowing in the light emitting devices when corresponding storage devices are being charged with the pixel data. The plurality of pixel circuits include rows of pixel circuits, and each switch prevents current from flowing in the light emitting devices of one of the rows when corresponding storage devices are being charged with the pixel data. The display includes spacers between rows of pixel circuits, each spacer having an upper portion that is wider than a lower portion, the lower portion being closer to a substrate on which the light emitting device is positioned.

Each light emitting device includes a light emitting layer positioned between a first electrode and a second electrode, and the first electrodes of the light emitting devices of the pixel circuits in each row are electrically coupled together. The first electrodes of the pixel circuits in each row are electrically coupled to a corresponding one of the switches. Each switch includes a thin film transistor. The light emitting device includes a first terminal and a second terminal, the first terminal is electrically coupled to the driving device, and the second terminal is electrically coupled to a corresponding one of the switches. Each switch is electrically coupled between the second terminals of corresponding light emitting devices and a constant voltage source or ground. The light emitting device includes a light emitting diode, the first terminal includes an anode, and the second terminal includes a cathode. The light emitting device includes an organic light emitting device.

In another aspect, in general, a display includes a plurality of pixel circuits, each pixel circuit including a light emitting device to emit light, a driving device to drive the light emitting device, and a storage device to store pixel data for controlling the driving device. The display includes a plurality of switches, each switch being connected in series with the light emitting devices of at least two pixel circuits to prevent current from flowing in the light emitting devices when corresponding storage devices are being charged with the pixel data.

Implementations of the display can include one or more of the following features. The light emitting device includes a light emitting diode having an anode and a cathode. For each pixel circuit, the anode is electrically connected to the driving device and the cathode is electrically connected to a corresponding switch.

In another aspect, in general, a display includes a plurality of pixel circuits, each pixel circuit including a light emitting device. The display also includes a switch electrically coupled to the light emitting devices of at least two pixels to control whether electric currents flow through the light emitting devices, the switch being connected in series with each of the at least two light emitting devices.

Implementations of the display can include one or more of the following features. The plurality of pixel circuits includes a row of pixel circuits, and the switch controls whether currents flow through the light emitting devices of all the pixel circuits in the row. Each light emitting device includes a light emitting layer positioned between a first electrode and a second electrode, and the first electrodes of the light emitting devices of the at least two light emitting devices are electrically connected to the corresponding switch.

In another aspect, in general, a method of operating a display includes controlling electric currents flowing through light emitting devices of a plurality of pixel circuits by using a plurality of switches that are positioned external to the plurality of pixel circuits, each switch controlling the electric currents that flow through the light emitting devices of at least two pixel circuits, each switch being connected in series with corresponding light emitting devices.

In another aspect, in general, a method of operating a display includes charging storage capacitors of a row of pixel circuits of a display, each pixel circuit including a driving transistor and a light emitting device, the light emitting devices of the row of pixel circuits being coupled to a common switch. The method also includes, while charging the storage capacitors of the row, turning off the switch to prevent current from flowing through the light emitting devices in the row of pixel circuits.

In another aspect, in general, a method of fabricating a display includes forming spacers above a substrate using negative photoresist patterning, the spacers having a wider upper portion and a narrower lower portion, the lower portion being closer to the substrate than the upper portion, and forming a light emitting layer in regions between the spacers.

In another aspect, in general, a pixel circuit in a flat panel display having a plurality of scan lines and a plurality of data lines, the pixel circuit including a first transistor, a second transistor, a third transistor, a capacitor, and a light emitting device. The first transistor has a first source/drain electrode coupled to a first voltage. The capacitor is coupled to the first source/drain electrode and a gate electrode of the first transistor. The second transistor includes a first source/drain electrode and a second source/drain electrode coupled to the gate electrode and a second source/drain electrode of the first transistor, respectively, and a gate electrode coupled to one of the scan lines. The third transistor includes a first source/drain electrode and a gate electrode coupled to the second source/drain electrode and the gate electrode of the second transistor, respectively, and a second source/drain electrode coupled to one of the data lines. The light emitting device includes an anode end coupled to the second source/drain electrode of the second transistor, and a cathode end coupled to a switch that determines whether the cathode end is coupled to a second voltage that is lower than the first voltage.

Implementations of the pixel circuit can include one or more of the following features. The light emitting device includes an organic light emitting diode.

In another aspect, in general, a flat panel display includes a plurality of scan lines, a plurality of data lines, and a plurality of pixel circuits each corresponding to one of the scan lines and one of the data lines. The display includes a plurality of cathode lines, in which the pixel circuits that are coupled to a common scan line are also coupled to a common cathode line. The display also includes a plurality of switch circuits each coupled to a corresponding cathode line, in which each of the switch circuits controls whether the corresponding cathode line is connected to a working voltage.

Implementations of the display can include one or more of the following features. The display includes a data line driving circuit for generating driving signals to be transmitted on the data lines. The data line driving circuit also generates control signals to control the switch circuits. The timing of the control signals for controlling the switch circuits have a relationship with the timing of the driving signals transmitted on the data lines. Each of the pixel circuits includes a light emitting device having an anode end and a cathode end, the anode end being electrically connected to a driving transistor, the cathode end being electrically connected to one of the cathode lines.

In another aspect, in general, a flat panel display, includes a transistor disposed on a substrate, the transistor including a drain electrode, and a first insulating layer disposed on the transistor, the first insulating layer defining a trench having an opening to expose the drain electrode of the transistor. An anode electrode is disposed on the first insulating layer, and a second insulating layer covers at least a portion of the anode electrode. At least two spacer structures are disposed on the second insulating layer at two sides of the anode electrode, each spacer structure having an upper portion that is wider than a lower portion, the lower portion being closer to the substrate than the upper portion. An organic light emitting layer is disposed above the second insulating layer in an area between the two spacer structures, and a cathode electrode is disposed above the light emitting organic layer in an area between the two spacer structures. A switch element is coupled to the cathode electrode for controlling whether to conduct a voltage to the cathode electrode.

Implementations of the display can include one or more of the following features. The anode electrode includes at least one of indium tin oxide, indium zinc oxide, and aluminum zinc oxide. The cathode electrode includes at least one of aluminum, calcium, and magnesium silver alloy.

Advantages of the displays and methods may include one or more of the following. The pixel circuits can have a smaller leakage current flowing from the light emitting devices while the storage capacitors are being charged with pixel data, improving the image quality of the display. The switch for controlling whether the light emitting device conducts current is positioned external to the pixel circuits, and each switch corresponds to the light emitting devices of multiple pixel circuits, so that the number of transistors in each pixel circuit can be reduced. The spacer structures have an inverted trapezoidal shape, allowing the light emitting layer and the cathode electrode to be formed without an additional mask, simplifying the manufacturing process.

### DESCRIPTION OF DRAWINGS

FIG. 1 is a circuit diagram of a pixel circuit.

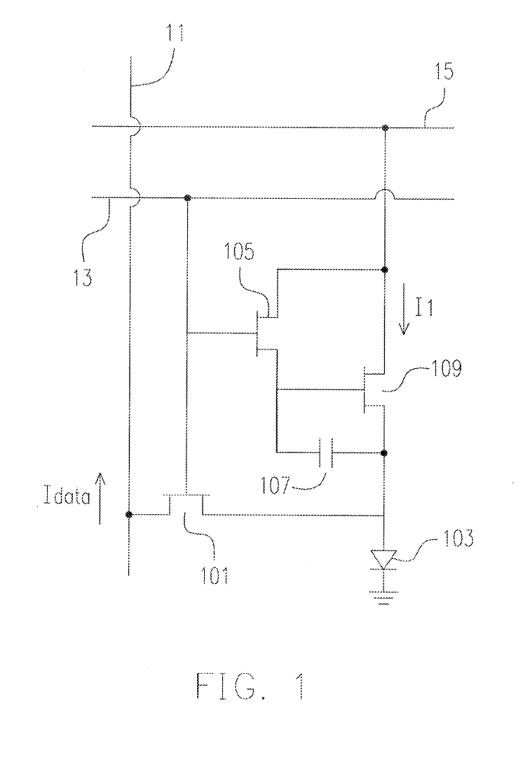

FIG. 2 is a schematic circuit diagram of a flat panel display.

FIG. 3 is a circuit diagram of a pixel circuit.

FIG. 4 is a timing diagram of a signal for controlling a pixel circuit.

FIG. 5 is a circuit diagram of a pixel circuit.

FIG. 6 is a schematic structural view of a display panel.

FIG. 7 is a sectional view of a portion of the display panel of FIG. 6.

### DESCRIPTION

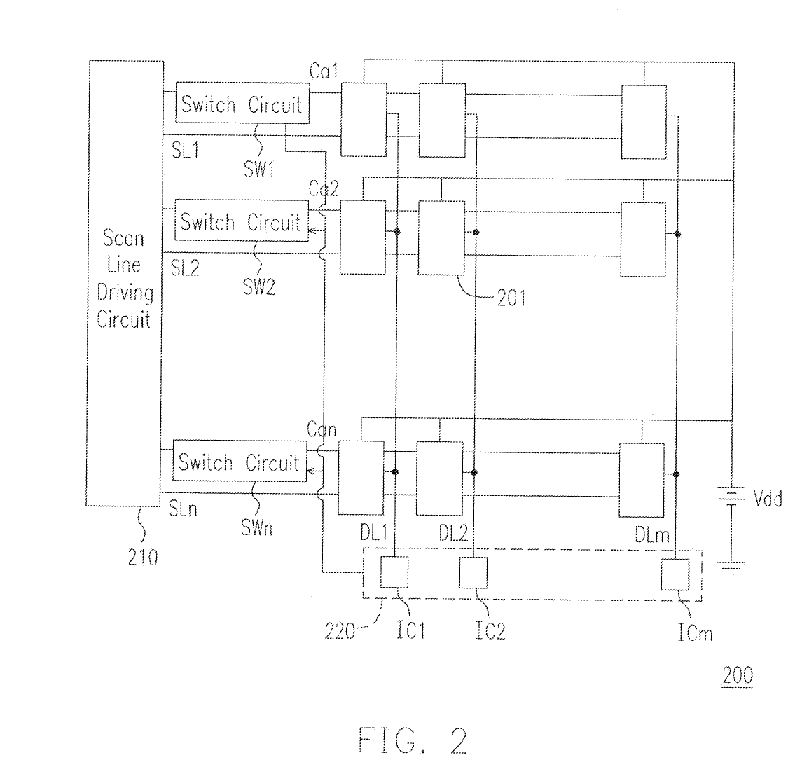

FIG. 2 is a schematic circuit diagram of an example of a flat panel display 200, which includes scan lines SL1-SLn and data lines DL1-DLm. The scan lines SL1-SLn are arranged in parallel along a first direction. The data lines DL1-DLm are arranged along a second direction. The data lines DL1-DLm do not contact the scan lines SL1-SLn. Pixel circuits are positioned at intersections of the data lines DL1-DLm and scan lines SL1-SLn. For example, a pixel circuit 201 is positioned at an intersection of the data line DL2 and the scan line SL2. The flat panel display 200 includes cathode lines Ca1-Can arranged in parallel with the scan lines SL1-SLn. The pixel circuits that are coupled to the same scan line are also coupled to the same cathode line, and each of the cathode lines is coupled to a corresponding switch circuit (SW1-SWn). For example, the pixel circuits that are coupled to the scan line SL2 are coupled to the cathode line Ca2, which is coupled to the switch circuit SW2. Each switch circuit, controlled by a control signal, determines whether a working voltage is coupled to the cathode line.

The flat panel display 200 includes a scan line driving circuit 210 and a data line driving circuit 220. The scan line driving circuit 210 is coupled to the scan lines SL1-SLn for generating scanning signals. The scanning signals are transmitted to corresponding scan lines sequentially to activate the pixel circuits coupled to the scan lines. The data line driving circuit 220 includes driving chips IC1-ICm, which are used to send the driving current Idata to the pixel circuits (e.g., 201).

The data line driving circuit 220 generates control signals for controlling the switch circuits SW1 to SWn. For example, after chips IC1 to ICm send driving current Idata to write the pixel data to the first row of pixel circuits, the data line driving circuit 220 sends a control signal to turn on SW1 to enable the OLEDs in the first row to emit light.

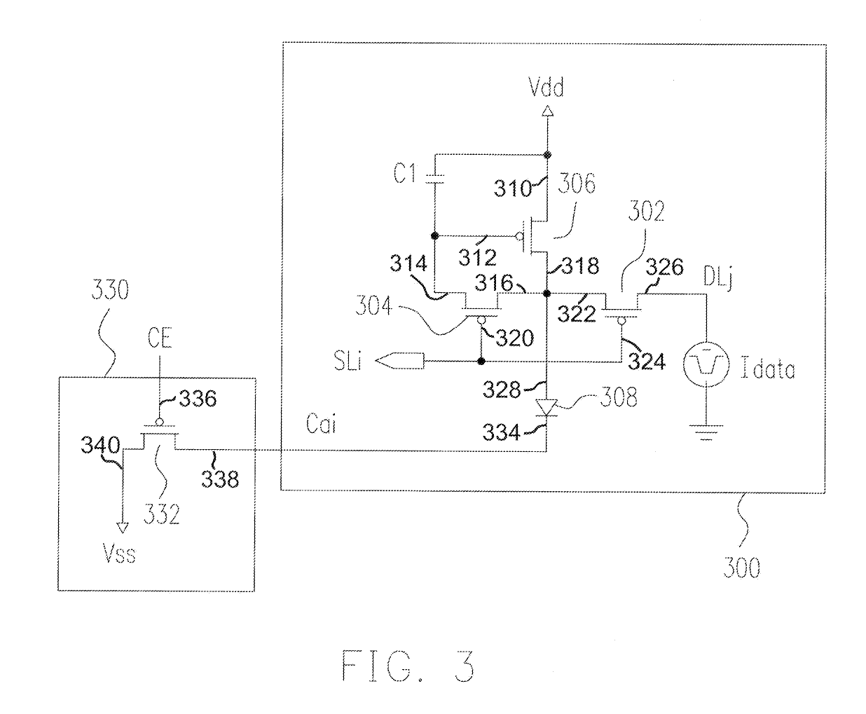

FIG. 3 is a circuit diagram of an example of a current-drive pixel circuit 330, which can be used in the flat panel display 200 of FIG. 2. The pixel circuit 300 includes transistors 302, 304, and 306. A first source/drain electrode 310 of the transistor 306 is coupled to a DC voltage Vdd. A capacitor C1 is coupled to the first source/drain electrode 310 and a gate electrode 312 of the transistor 306. A first source/drain electrode 314 and a second source/drain electrode 316 of the transistor 304 are coupled to the gate electrode 312 and a second source/drain electrode 318 of the transistor 306, respectively. A gate electrode 320 of the transistor 304 is coupled to a scan line SLi, which can be one of the scan lines SL1-SLn in FIG. 2.

A first source/drain electrode 322 and a gate electrode 324 of the transistor 302 are coupled to the second source/drain electrode 316 and the gate electrode 320 of the transistor 304, respectively. A second source/drain electrode 326 of the transistor 302 is coupled to a data line DLj, which can be one of the data lines DL1-DLn in FIG. 2.

The pixel circuit 300 includes a light emitting device (LED) 308, which can be an organic light emitting device. In this example, the light emitting device 308 is a light emitting diode. An anode end 328 of the LED 308 is coupled to the first source/drain electrode 322 of the transistor 302, and a cathode end 334 of the LED 308 is coupled to a corresponding switch circuit 330 through a cathode line Cai, which can be one of the cathode lines Ca1-Can in FIG. 2.

The switch circuit 330 can include, e.g., a transistor 332. The transistor 332 has a first source/drain electrode 340 coupled to a working voltage Vss, a gate electrode 336 coupled to a control signal CE, and a second source/drain electrode 338 coupled to the cathode line Cai.

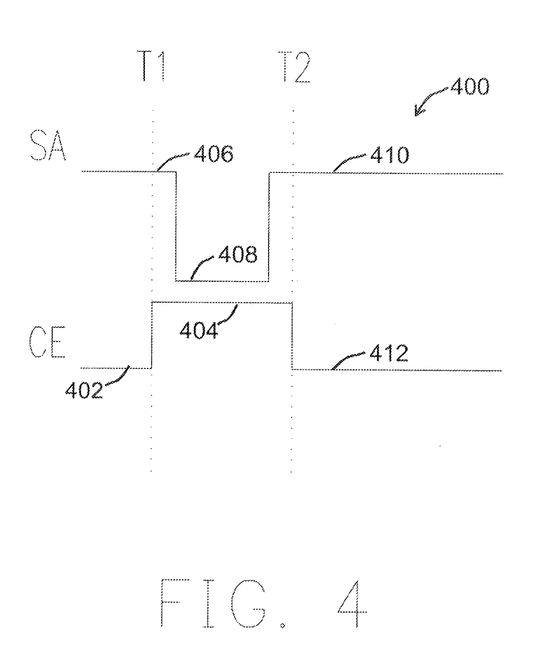

FIG. 4 is an example of a timing diagram 400 of the CE control signal and an SA signal on the scan line SLi for controlling the pixel circuit 300 of FIG. 3. In the example of FIG. 3, the transistors 302, 304, 306, and 322 are PMOS transistors. Referring to FIGS. 3 and 4 together, at time T1, the control signal CE changes from a low level 402 to a high level 404, such that the transistor 332 is turned off and assumes a floating state. The scanning signal SA changes from a high level 406 to the low level 408, such that the transistors 302 and 304 are turned on. At this time, a data driving current Idata flows to a ground terminal through the transistor 306 and the data line DLj, and charges the capacitor C1, such that pixel data of the pixel circuit 300 is stored as a voltage level across the capacitor C1.

The scanning signal SA rises from the low level 408 to the high level 410, such that the transistors 302 and 304 are turned off. At time T2, the control signal CE changes from the high level 404 to the low lever 412, such that the transistor 332 is turned on. At this time, the capacitor C1 provides a voltage level across the gate 312 and the first source/drain electrode 310 of the driving transistor 306, causing the driving transistor 306 to drive the LED 308 according to the pixel data.

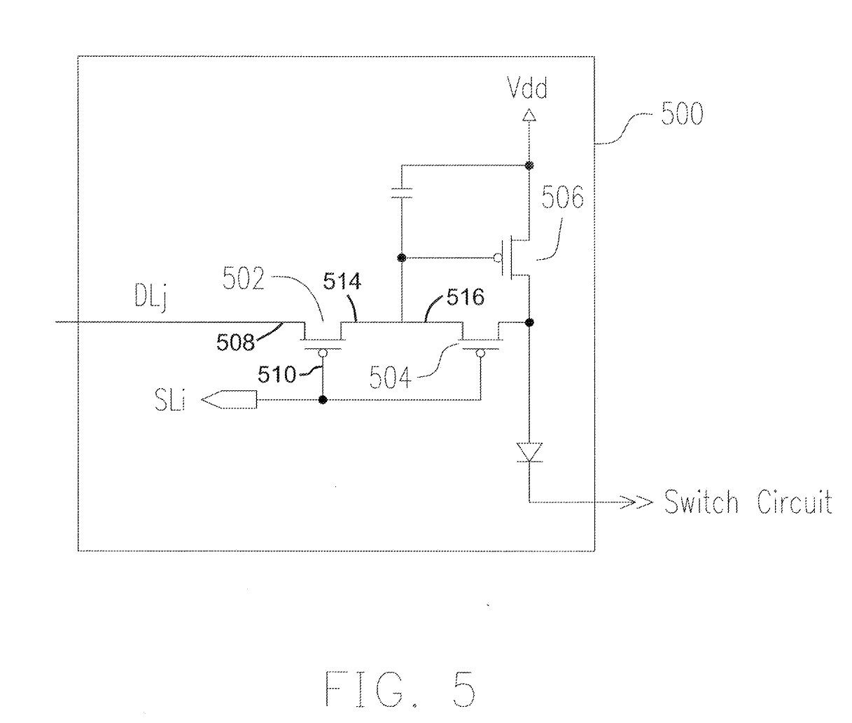

FIG. 5 is a circuit diagram of an example of a pixel circuit 500 that operates in a manner similar to the pixel circuit 300 of FIG. 3. The pixel circuit 500 includes three transistors 502, 504, and 506, in which the transistors 504 and 506 are connected in a manner similar to the transistors 304 and 306 of FIG. 3. The transistor 502 has a source/drain electrode 508 that is coupled to the data line DLj. A gate electrode 510 of the transistor 502 and a gate electrode 512 of the transistor 504 are both coupled to the scan line SLi. A second source/drain electrode 514 of the transistor 502 is coupled to a first source/drain electrode 516 of the transistor 504. Control signals similar to those shown in FIG. 4 can be used to control the pixel circuit 500.

In the examples of pixel circuits 300 and 500, the transistors 302, 304, 306, 332, 502, 504, and 506 are PMOS transistors. In some examples, the PMOS transistors of pixel circuits 300 and 500 can be replaced with NMOS transistors. A combination of NMOS and PMOS transistors can also be used in the pixel circuits.

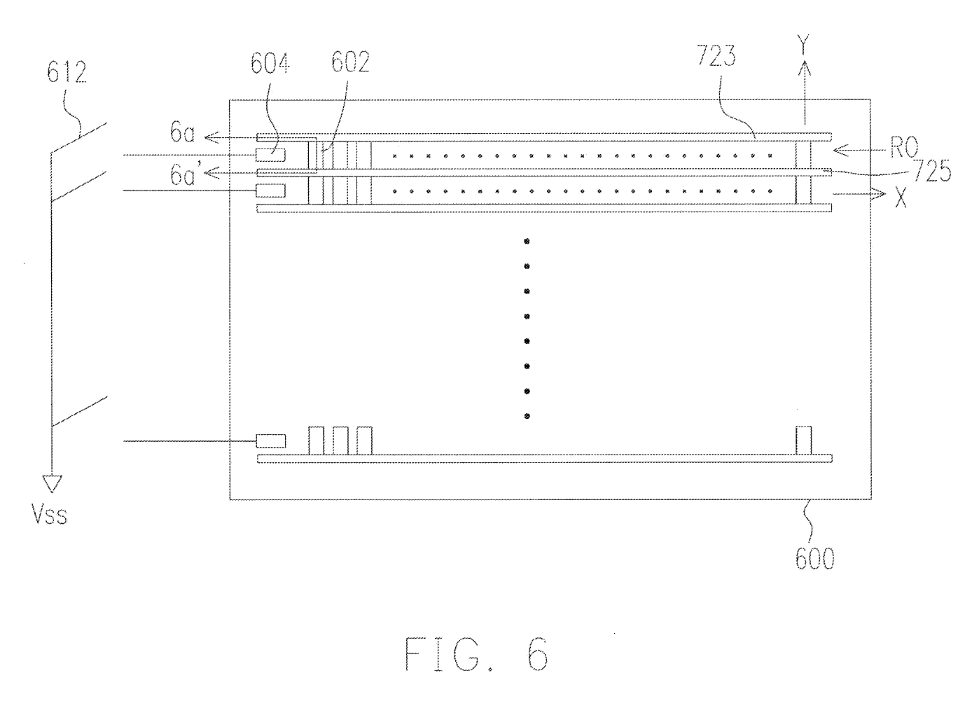

FIG. 6 is a schematic structural diagram of an example of a display panel 600 that includes the circuit components of the flat panel display 200 of FIG. 2. The display panel 600 includes a plurality of pixel structures formed with anode electrodes, e.g., 602. The pixel structures are arranged in an array on the display panel 600. Each of the anode electrodes extends along a Y direction. The pixel structures of a row share one cathode electrode (i.e., the cathode electrode extends an entire row). The cathode electrode of each row of pixel structures is coupled to a switch circuit through a cathode contact terminal. For example, the pixel structures in row R0 share one cathode electrode that is coupled to a switch circuit 612 through a cathode contact terminal 604. Each of the cathode electrodes extends along an X direction. The switch circuit 612 can be implemented using the transistor 332 of FIG. 3. Each of the switch circuits is controlled by a control signal. Each switch circuit controls whether the working voltage Vss is coupled to a corresponding cathode electrode.

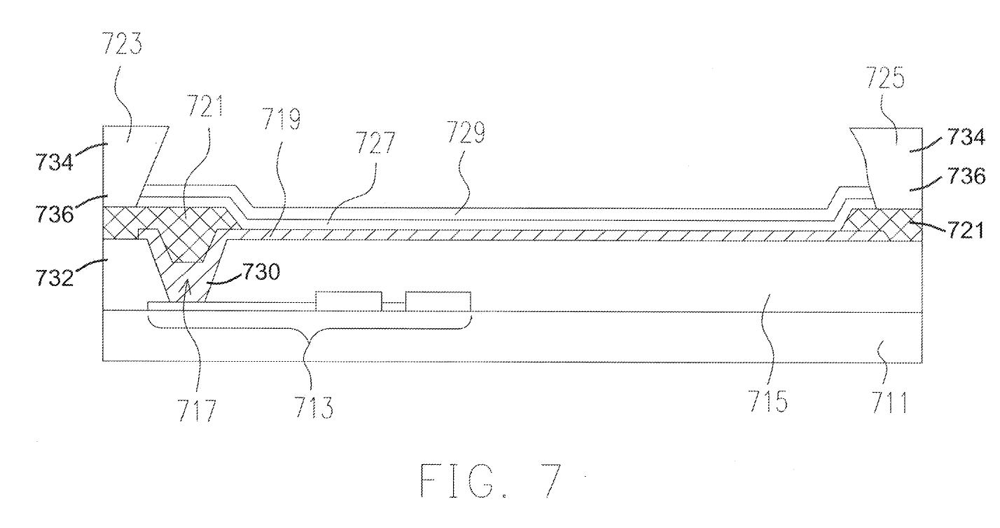

FIG. 7 is a sectional view taken along 6a-6a′ of FIG. 6. For example, a thin-film transistor device 713 is disposed on a substrate 711. The transistor device 713 can be, e.g., any one of transistors 302, 304, and 306 of FIG. 3, or any one of transistors 502, 504, and 506 of FIG. 5. Other transistors are not shown in FIG. 7. An insulating layer 715 is formed on the transistor device 713. An opening, trench, or a groove 717, is formed in the insulating layer 715 to expose a drain electrode of the transistor device 713.

A layer of anode electrode 719 is formed on the insulating layer 715. The anode electrode 719 can be, e.g., the anode electrode 602 of FIG. 6. The material of the anode electrode can be indium zinc oxide, indium zinc oxide, or aluminum zinc oxide, or any combination of the above. The groove 717 is partially filled by the anode electrode 719, in which the anode electrode 719 coupled and covers the drain portion of the thin-film transistor device 713. The anode electrode 719 also covers a portion of the insulating layer 715.

An insulating layer 721 is formed and covers a portion 730 of the anode electrode 719 in the groove 717 and a portion 732 of the insulating layer 715 that is not covered by the anode electrode 719. The materials of the insulating layers 715 and 721 include, e.g., silicon dioxide.

Spacer structures 723 and 725 are formed on the insulating layer 721. The spacer structures 723 and 725 are disposed at two ends of the anode electrode 719 and extend along the X direction in FIG. 6. The spacer structures 723 and 725 are formed by negative photoresist patterning. This results in the spacer structures 723 and 725 having inverted trapezoidal shapes, in which the upper portions of the spacer structures 723 and 725 are wider, and the lower portions of the spacer structures 723 and 725 are narrower.

An organic layer 727 is deposited in the area between the spacer structures 723 and 725. The organic layer 727 has a light-emitting characteristic. The material of the organic layer 727 can be, e.g., a small molecular organic material or a high molecular organic material. A cathode electrode 729 is overlaid on the organic layer 727. The material of the cathode electrode 729 can include, e.g., aluminum, calcium, or magnesium silver alloy, or any combination of the above.

The organic layer 727 and the cathode electrode 729 both extend along the X direction of FIG. 6. The cathode electrode 729 is coupled to the corresponding switch circuit (e.g., 612) through the cathode contact terminal (e.g., 604). As the spacer structures 723 and 725 are formed with negative photoresist, it can be seen from FIG. 6 that the spacer structures 723 and 725 have inverted trapezoidal structures. In some examples, the organic layer 727 and the cathode electrode 729 can be formed without an additional mask, with the spacer structures 723 and 725 separating the organic layers 727 and cathode electrodes 729 of different rows.

When the organic material for the organic layer 727 is formed on the anode electrode 719 and the spacer structures 723 and 725, the organic material separates at the spacer structures 723 and 725, so that the organic layer 727 of one row is separated from the organic layer 727 of another row. The organic material remaining on the spacer structures 723 and 725 can be etched away. Similarly, when the material for the cathode electrode 729 is formed on the organic layer 727 and the spacer structures 723 and 725, the cathode electrode material separates at the spacer structures 723 and 725, so that the cathode electrode 729 of one row is separated from the cathode electrode 729 of another row. The cathode electrode material remaining on the spacer structures 723 and 725 can be etched away. This simplifies the processing steps for manufacturing the display panel 600.

The examples described above can have one or more of the following advantages. The data driving currents of the pixel circuits can be controlled by turning the switch circuits on or off, so that the flat panel display can operate more efficiently. The switch circuit enter a floating state when the capacitor (e.g., C1 of FIG. 3) is being charged to store the pixel data, so the LEDs have reduced or no leakage current. The working voltage Vss can be set according to different levels depending on application, allowing flexibility in the design of the display panel. The spacer structures have inverted trapezoidal structures, allowing various layers of the light emitting device to be formed with a reduced number of masks (as compared to a process that does not use spacer structures having inverted trapezoidal shapes), simplifying the manufacturing of the display panel.

A number of embodiments of the invention have been described. Nevertheless, it will be understood that various modifications may be made without departing from the spirit and scope of the invention. For example, the materials for various components, such as the organic layer and electrodes, can be different from those described above. The control signal waveforms can be different from those described above. Accordingly, other implementations are within the scope of the following claims.

What is claimed is:

1. A display comprising:
a plurality of pixel circuits, each pixel circuit comprising
a light emitting device,
a driving device to drive the light emitting device, and
a storage device to store pixel data for controlling the driving force; and
a plurality of switches external to the plurality of pixel circuits, each switch being connected in series with a corresponding one or more of the light emitting devices.

2. The display of claim 1 wherein each switch is configured to prevent current from flowing in the corresponding one or more light emitting devices when corresponding storage devices are being charged with the pixel data.

3. The display of claim 1 wherein each switch corresponds to the light emitting devices of at least two pixel circuits and prevents current from flowing in the light emitting devices when corresponding storage devices are being charged with the pixel data.

4. The display of claim 1 wherein the plurality of pixel circuits comprise rows of pixel circuits, and each switch prevents current from flowing in the light emitting devices of one of the rows when corresponding storage devices are being charged with the pixel data.

5. The display of claim 4, further comprising spacers between rows of pixel circuits, each spacer having an upper portion that is wider than a lower portion, the lower portion being closer to a substrate on which the light emitting device is positioned.

6. The display of claim 4 wherein each light emitting device comprises a light emitting layer positioned between a first electrode and a second electrode, and the first electrodes of the light emitting devices of the pixel circuits in each row are electrically coupled together.

7. The display of claim 6 wherein the first electrodes of the pixel circuits in each row are electrically coupled to a corresponding one of the switches.

8. The display of claim 1 wherein each switch comprises a thin film transistor.

9. The display of claim 1 wherein the light emitting device comprises a first terminal and a second terminal, the first terminal is electrically coupled to the driving device, and the second terminal is electrically coupled to a corresponding one of the switches.

10. The display of claim 9 wherein each switch is electrically coupled between the second terminals of corresponding light emitting devices and a constant voltage source or ground.

11. The display of claim 9 wherein the light emitting device comprises a light emitting diode, the first terminal comprises an anode, and the second terminal comprises a cathode.

12. The display of claim 1 wherein the light emitting device comprises an organic light emitting device.

13. A display comprising:
a plurality of pixel circuits, each pixel circuit comprising
a light emitting device to emit light,
a driving device to drive the light emitting device, and
a storage device to store pixel data for controlling the driving device; and
a plurality of switches, each switch being connected in series with the light emitting devices of at least two pixel circuits to prevent current from flowing in the light emitting devices when corresponding storage devices are being charged with the pixel data.

14. The display of claim 13 wherein the light emitting device comprises a light emitting diode having an anode and a cathode.

15. The display of claim 14 wherein for each pixel circuit, the anode is electrically connected to the driving device and the cathode is electrically connected to a corresponding switch.

16. A display comprising:
a plurality of pixel circuits, each pixel circuit comprising a light emitting device; and
a switch electrically coupled to the light emitting devices of at least two pixel circuits to control whether electric currents flow through the light emitting devices, the switch being connected in series with each of the at least two light emitting devices.

17. The display of claim 16 wherein the plurality of pixel circuits comprise a row of pixel circuits, and the switch controls whether currents flow through the light emitting devices of all the pixel circuits in the row.

18. The display of claim 16 wherein each light emitting device comprises a light emitting layer positioned between a first electrode and a second electrode, and the first electrodes of the light emitting devices of the at least two pixel circuits are electrically connected to the corresponding switch.

19. A method of operating a display, comprising:
controlling electric currents flowing through light emitting devices of a plurality of pixel circuits by using a plurality of switches that are positioned external to the plurality of pixel circuits, each switch controlling the electric currents that flow through the light emitting devices of at least two pixel circuits, each switch being connected in series with corresponding light emitting devices.

20. A method of operating a display, comprising:
charging storage capacitors of a row of pixel circuits of a display, each pixel circuit comprising a driving transistor and a light emitting device, the light emitting devices of the row of pixel circuits being coupled to a common switch; and
while charging the storage capacitors of the row, turning off the switch to prevent current from flowing through the light emitting devices in the row of pixel circuits.

21. A method of fabricating a display, comprising:
forming spacers above a substrate using negative photoresist patterning, the spacers having a wider upper portion and a narrower lower portion, the lower portion being closer to the substrate than the upper portion;
forming a light emitting layer in regions between the spacers, the light emitting layer extending over a row of pixels located at a first area;
forming an electrode above the light emitting layer, the electrode extending over the row of pixels; and
connecting the electrode to a switch located in a second are outside of the first area.

22. A pixel circuit in a flat panel display having a plurality of scan lines and a plurality of data lines, the pixel circuit comprising:
a first transistor comprising a first source/drain electrode coupled to a first voltage;
a capacitor that is coupled to the first source/drain electrode and a gate electrode of the first transistor;
a second transistor comprising a first source/drain electrode and a second source/drain electrode coupled to the gate electrode and a second source/drain electrode of the first transistor, respectively, and a gate electrode coupled to one of the scan lines;
a third transistor comprising a first source/drain electrode and a gate electrode coupled to the second source/drain electrode and the gate electrode of the second transistor, respectively, and a second source/drain electrode coupled to one of the data lines; and
a light emitting device comprising an anode coupled to the second source/drain electrode of the second transistor, and a cathode coupled to a switch that determines whether the cathode is coupled to a second voltage that is lower than the first voltage.

23. The pixel circuit of claim 22 wherein the light emitting device comprises an organic light emitting diode.

24. A flat panel display, comprising:
a plurality of scan lines;
a plurality of data lines;
a plurality of pixel circuits, each corresponding to one of the scan lines and one of the data lines;
a plurality of cathode lines, wherein the pixel circuits that are coupled to a common scan line are also coupled to a common cathode line; and
a plurality of switch circuits, each coupled to a corresponding cathode line, wherein each of the switch circuits controls whether the corresponding cathode line is connected to a working voltage.

25. The display of claim 24, further comprising a data line driving circuit for driving the data lines.

26. The display of claim 25 wherein the data line driving circuit also generates control signals to control the switch circuits.

27. The display of claim 26 wherein the timing of the control signals for controlling the switch circuits have a predefined relationship with the timing of driving signals transmitted on the data lines.

28. The display of claim 26 wherein each of the pixel circuits comprises a light emitting device having an anode and a cathode, the anode being electrically connected to a driving transistor, the cathode being electrically connected to one of the cathode lines.

29. A flat panel display, comprising:
a transistor disposed on a substrate, the transistor comprising a drain electrode;
a first insulating layer disposed on the transistor, the first insulating layer defining an opening to expose the drain electrode of the transistor;
an anode electrode disposed on the first insulating layer and contacting the exposed drain electrode;
a second insulating layer covering at least a portion of the anode electrode;
at least two spacer structures disposed on the second insulating layer at two sides of the anode electrode, each spacer structure having an upper portion that is wider than a lower portion, the lower portion being closer to the substrate than the upper portion
an organic light emitting layer disposed above the second insulating layer in an area between the two spacer structures;
a cathode electrode disposed above the light emitting organic layer in an area between the two spacer structures; and
a switch element coupled in series with the cathode electrode.

30. The display of claim 29 wherein the anode electrode comprises at least one of indium tin oxide, indium zinc oxide, and aluminum zinc oxide.

31. The display of claim 29 wherein the cathode electrode comprises at least one of aluminum, calcium, and magnesium silver alloy.
